(19) United States
(12) Patent Application Publication
(10) Pub. No.: US 2003/0036366 A1
(43) Pub. Date: Feb. 20, 2003

(54) Web telephone set that can make an internet phone

(76) Inventor: Tai Wo Ng, Kowloon (HK)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/217,316

(22) Filed: Aug. 9, 2002

(30) Foreign Application Priority Data
Aug. 9, 2001 (CN) 01243181.8

(51) Int. Cl. H04B 5/00; H04B 1/38

(52) U.S. Cl. 455/90; 455/41

(57) ABSTRACT

This functional and innovative product is a networking telephone unit with IP dialing function, consisting of body, keypad, and remote-controlled multiplex execution unit. On the panel of the body, there are a telephone set; a display screen, and an input stylus. The body is wired with the keypad. The remote-controlled multiplex execution unit is independent. There are integrated circuits inside the body, including a power unit and CPU that enable phone calls, online browsing, and e-mail function through connection with an infrared transceiver, memory, display screen, touch screen, voice input/output module, series-parallel ports, voice coder, keypad, USB port, Ethernet port, modem, and telephone module. Featuring streamlined structure, which is user-friendly, stylish, functional, and cost efficient, this product is designed to make IP phone calls, browse Internet, and process e-mail, as well as to be used as a fixed telephone; thus, it is ideal for family use.

### FIELD OF THE INVENTION

Based on terminal networking communications technology, this functional and innovative product is a networking telephone unit with IP dialing function.

### BACKGROUND OF THE INVENTION

Currently available IP dialing means are as follows:

Audio transmission via a computer that connects with the Internet by a modem, cable modem, or network interface card. NETMEETING™ is a typical one.

Use of mobile phone IP service accessed by dialing a telephone number designated by the service provider.

Use of telephone IP service accessed by dialing 17909 and other IP access numbers designated by the service provider.

Use of dedicated equipment or leased lines, such as IP card or Company IP Telephone Network.

The disadvantages of the IP dialing mentioned above are as follows:

IP dialing via a computer assumes that the user has a computer and some computer skills. In fact, only a small population in China falls into this category, so it is not good for networking applications and IT development.

Mobile phones are easy to use; however, their relatively limited functions and higher price prohibit wide application of networking.

The cost of dialing 17909 and other IP telephone numbers is also expensive and service is often unavailable. In addition, use of the service will be charged whether the call goes through or not.

With an IP card, a user has to key in a long number (IP card number and PIN); as to dedicated equipment, it involves mountainous investment in the equipment that is largely imported.

In addition, telephones that are currently used have no direct connection to the Internet, so that families have to expend large amounts of money on Internet access.

### SUMMARY OF THE INVENTION

This functional and innovative telephone unit that overcomes the currently available technology is designed to make IP phone calls, browse the Internet, and process e-mail, as well as to be used as a fixed telephone; thus, it is ideal for family use.

This networking telephone unit with IP dialing function consists of a body, keypad, and a remote-controlled multiplex execution unit. On the panel of the body, there is a telephone set, and next to the telephone set is a display screen with an input stylus beneath it. The body is wired with the keypad. The remote-controlled multiplex execution unit is independent. There are integrated circuits inside the body, including a power unit and CPU that enable phone calls, online browsing, and e-mail function through respective connection with an infrared transceiver, memory, display screen, touch screen, voice input/output module, series-parallel ports, voice coder, keypad, USB port, Ethernet port, modem, and telephone module.

With this functional and innovative telephone unit, one can make IP phone calls, browse the Internet, and process e-mail—as well as use it as a fixed telephone; thus, it is ideal for family use.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates the overall structure; and

FIG. 2 illustrates the frame chart of the integrated circuit.

### DETAILED DESCRIPTION OF THE PREFERRED EMBODIMENT

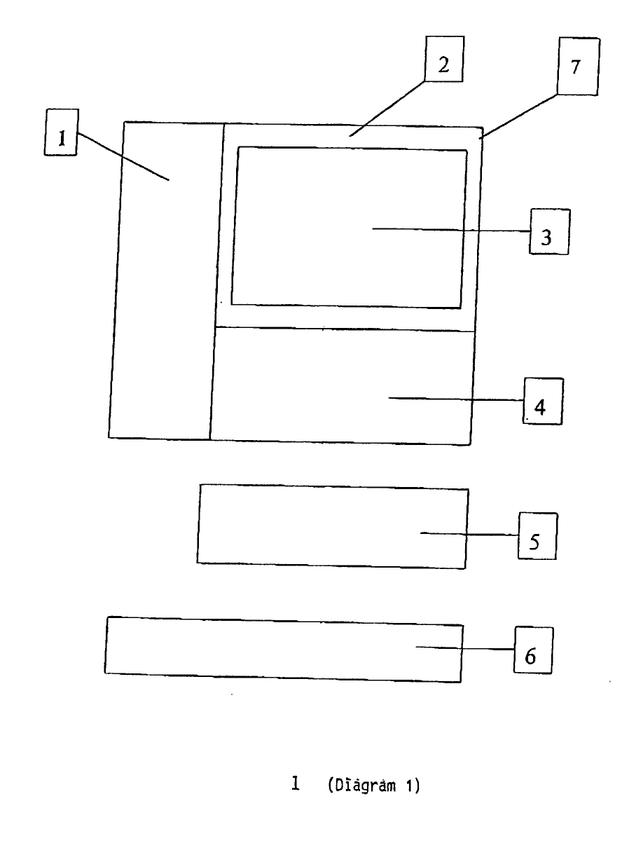

Referring to FIG. 1, this product consists of a body 7, keypad 5, and remote-controlled multiplex execution unit 6. On the body 7, there is a telephone set 1; next to it is a display screen 2 with an input stylus 4 beneath it. The display screen 2 is covered with a touch screen 3. The body 7 is wired with the keypad 5. The remote-controlled multiplex execution unit 6 is independent. There are integrated circuits inside the body 7. The telephone set 1 is used to call or answer; the display screen 2 shows the message; the touch screen 3, stylus 4, and keypad 5 are input devices. The remote-controlled multiplex execution unit 6 is used to receive a host signal and control appliances.

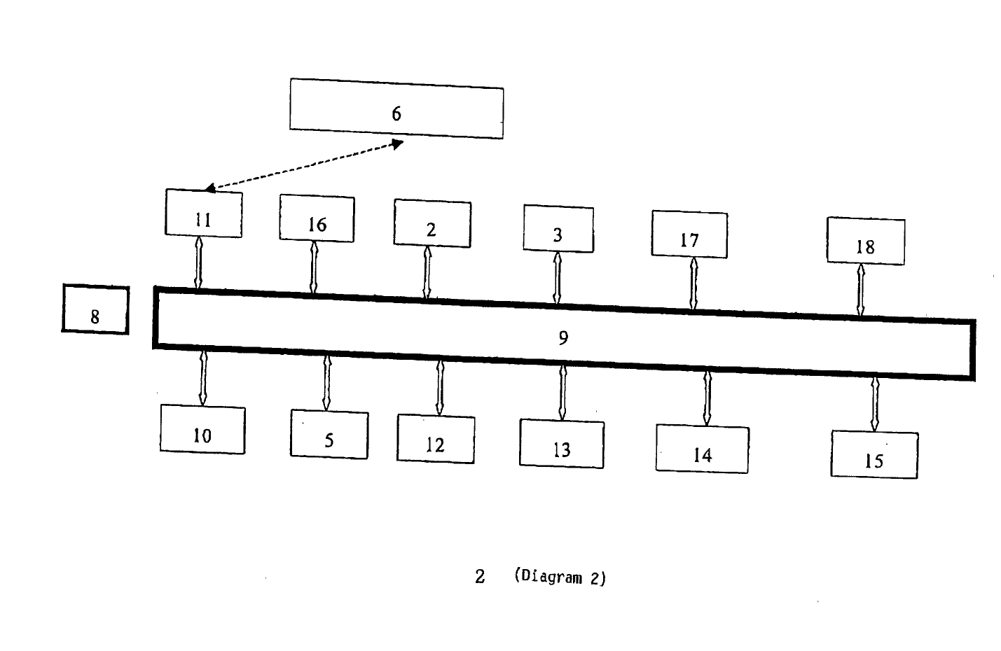

Referring to FIG. 2, it is a frame chart of the integrated circuit that includes the power unit 8 and CPU 9, which is connected with an infrared transceiver 1, memory 16, display screen 2, touch screen 3, voice I/O module 17, series-parallel ports 18, voice coder 10, keypad 5, USB port 12, Ethernet port 13, modem 14, and telephone module 15. CI-EP7312 used in the CPU 9 of this unit is an ARM720TDMI chip. FLASH and RAM of the memory 3 are used to store programs and data with large storage capacity, in which the FLASH is of INTEL E28F128J3A150 type and the SDRAM is of MT48LC4M16A2TG-7E or NEC UPD4564163G5-A80 type. The remote-controlled multiplex execution unit 6, which uses TFDS4500 to convert an infrared signal into a corresponding electronic signal and controls appliances via a PIC16C554 single chip processor, works with the infrared transceiver 11, which uses TFDS4500 to transmit or receive infrared signals upon host instructions. The voice I/O module 17 is for recording and MP3 listening; for voice input, CS43L32 or TSSOP20 is used to convert between digital and analog transmissions. The series-parallel ports 18 are used to connect printer or other peripheral equipment. The power unit 8 provides power for the system. The voice coder 10, made of TCM29C13 and AC48301A, is mainly used in voice coding (G.711, G.723.1, and G.729.A) for IP calls and echo effect elimination or delay processing. The USB port 12 is used to expand functions and the Ethernet port 13 enables this unit to access a LAN or broadband network at 10M/100M speed. The modem 14 is a standard V.90 56K type, and the telephone module 15 is used to accomplish telephone functions.

The software system consists of four parts:

1. Imbedded LINUX OS. As the platform necessary for all other software operation, it has fast speed, powerful function, extendable capacity, and rich online resources.

2. NANO-X or MICROWIN Windows® Management System. This is a Windows®-based graphical software for application management.

3. EMGTK gallery. It is necessary for operation of a graphical components program.

4. Various applications, such as browser, e-mail, and IP telephone applications. They work with specific hardware and functions.

Operation Procedures:

1) Dialing. It is used in the same way as a common telephone. Pick up the handset and press the dialing keys, then the number will show on the display. Or a receiver's name or other property is selected from the Address Book item in the menu on the screen, e.g., “John,” and the LCD will display “Telephone number: 01012345678,” “Enter” or “Cancel.” If “Enter” is chosen, the dialing will be done automatically. When the receiver answers, pick up the handset to talk.

2) World Wide Web (WWW) Browsing. Press “WEB” key on the panel, or select the function with stylus or keypad from the menu to make a dial-up connection.

3) Answering. This works the same way as a common telephone.

4) Automatic Answering. This unit will turn into Automatic Answering Mode on the fifth ring of a call without answering. First, the outgoing message is played, and then the message left by the caller will be recorded. During this process, receiving telephone calls is possible when the message is interrupted.

5) Message Playing. Press the “Message Play” key to play the message. Choose the previous or next one by pressing the button ≮ or ≯. Press “Switch Key” to exit the message play mode and enter the telephone mode.

6) Dial/Answer IP Telephone Call. Both parties of an IP telephone call have to be online via modem or Ethernet at the same time, when one party calls the other with the stylus or keypad on the telephone set.

7) MP3 Music. Activate the MP3 application on the screen to listen to MP3 music online through the earphone jack.

8) Chat and Play Games, Visit Libraries, and Complete Transactions Online. Activate the relevant applications from the menu on the screen and follow the instructions accordingly to chat and play games, visit libraries online, and complete transactions online.

9) Intelligent Functions: Home Security and Scheduling. Activate the relevant applications from the menu on the screen and follow the instructions accordingly to realize the intelligent functions through the infrared transceiver and remote-controlled multiplex execution unit.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A networking IP telephone unit, comprising:
a body containing integrated circuits therein;
a keypad wired with the body; and
a remote-controlled multiplex execution unit;
wherein the body includes a telephone set, a display screen, and an input stylus, the display screen being covered with a touch screen.

2. The telephone unit of claim 1, wherein the integrated circuits comprise:
a power unit; and
a CPU, which connects with an infrared transceiver, a memory, the display screen, the touch screen, a voice input/output module, a series-parallel ports, a voice coder, the keypad, a USB port, an Ethernet port, a modem, and a telephone module.
